(19) United States
(12) Patent Application Publication
(10) Pub. No.: US 2010/0257160 A1
(43) Pub. Date: Oct. 7, 2010

(54) METHODS & APPARATUS FOR SEARCHING WITH AWARENESS OF DIFFERENT TYPES OF INFORMATION

(76) Inventor: Yu Cao, Monterey Park, CA (US)

Correspondence Address: FISH & ASSOCIATES, PC;ROBERT D. FISH, 2603 Main Street, Suite 1000, Irvine, CA, 92614-6232, US

(21) Appl. No.: 12/757,423

(22) Filed: Apr. 9, 2010

Related U.S. Application Data
(63) Continuation-in-part of application No. 12/403,157, filed on Mar. 12, 2009.
Application No. 12/403,157 is a continuation of application No. 11/752,205, filed on May 22, 2007, now Pat. No. 7,523,108.
(60) Provisional application No. 60/811,989, filed on Jun. 7, 2006.

(51) Int. Cl. G06F 17/30

(52) U.S. Cl. 707/723; 707/E17.014

(57) ABSTRACT

A system that automatically discerns a best combination of parameters derived from types of information pertaining to a user query is presented. Search results are retrieved and displayed according to one or more best combinations of parameters. A record on the system is associated with various types of information (e.g., geographic locations, languages, brands, metadata, product classes, etc). A record could be composed of two or more records, each of which associates with one or more types of information. A record could be in rich media format.

### CROSS REFERENCE TO RELATED APPLICATIONS

This application is a continuation-in-part of U.S. patent application having Ser. No. 12/403157, filed on Mar. 12, 2009, which is a continuation of U.S. patent application Ser. No. 11/752205 filed May 22, 2007, now U.S. Pat. No. 7,523,108 issued on Apr. 21, 2009, which claims priority to U.S. patent application Ser. No. 60/811989 filed Jun. 7, 2006. These and all other extraneous materials discussed herein are incorporated by reference in their entirety. Where a definition or use of a term in an incorporated reference is inconsistent or contrary to the definition of that term provided herein, the definition of that term provider herein applies and the definition of that term in the reference does not apply.

### FIELD OF THE INVENTION

The field of the invention is searching technologies.

### BACKGROUND

Globalization necessitates an audience of diverse languages and geographic locations. To satisfy a user's information need, relevance is necessarily a function of both language and location.

Consider a company whose potential clients are in different countries and regions, speaking difference languages. The company's web site contains pages that are relevant for different clients. For example, one page aims at potential English-speaking clients from Los Angeles (“our sales office is a short distance from the Union Station . . .”); another page aims at potential clients from Los Angeles speaking Spanish; still another page at clients from Los Angeles speaking Chinese; and still another page at clients from Shanghai speaking Chinese (a Chinese equivalent of the following message “Our Shanghai office handles businesses throughout the Eastern China”).

Now suppose all these web pages are searchable through a search engine.

A user query submitted to the search engine might originate from any part of the world, and the user composes the query in a language of her choice. If the search engine can automatically discern the origin, and the language, of the query, then the engine can match information in the most appropriate combination of location and language, and display accordingly. For example, a barber shop's information is typically relevant only to a user from the same or neighboring zip codes, a CPA from the same or neighboring cities, and a software developer maybe the same country, all preferentially speaking the same language as a potential client.

In searching, the state of the art is to use information contained in user's browser and the user query to detect the country (in prior art FIG. 4, for example), or the geographic location (in prior art FIG. 5, for example), or the preferred language (in prior art FIG. 3, for example). There is also prior art that uses information provided by user's browser to determine both the country and the language (in prior art FIG. 2, for example).

The state of the art is not satisfactory. For one reason, geographic locations are of different “granularities” arranged in a hierarchical manner. It decidedly enhances relevance if the smallest possible granularity (many times much finer than “country”) is discerned, and used in searching. For example, the zip code 90024 corresponds to an area within the district of West Los Angeles, which in turn is within the city of Los Angeles, which in turn is part of the Greater Los Angeles, Southern California, Calif., America's West Coast, the United States of America, and North America. When the zip code 90024 is detected, search results associated with the zip code might be the most relevant, those associated with the district are less relevant, and in a decreasing order of relevance those associated with the city, the region, so on.

The state of the art is not satisfactory, for another reason, that sometimes there could be multiple detected locations. Further, sometimes there could be multiple detected languages. The state of the art uses only one pair of location and language, if that.

Further, the recent explosion of online videos for consumers, exemplified by contents on and visits to YouTube.com, leads to the contention that an explosion of online video for businesses is in the offing. Continuing the example above, suppose the company's web site features “About Us” videos that are dubbed in different languages aiming at different geographic locations. The need for a search engine to consider the best combinations of location and language is even more pronounced.

An observation from the example above is that many times a same piece of information exists in different languages for audiences in different locations, which calls for a means to identifying such relationships among records. Current state of the art does not speak to this.

The discussion above applies to records that comprise of Web pages, documents, catalogues, or advertisements.

What is still needed is methods that automatically discern geographic locations of the smallest possible granularity, determine the language or the languages of the user query, and evaluate the applicability of the geographic locations using at least the language or the languages. Once locations and languages are determined, best combinations of locations and language help retrieve and display records. Furthermore, more generic methods are also needed to identify records based on best combinations of different types of information beyond languages or locations.

### SUMMARY OF THE INVENTION

The inventive subject matter provides apparatus, systems and methods in which records are retrieved and presented to a user based on a best combination of parameters derived from different types of information.

One aspect of the inventive subject includes a method of providing records. An analysis engine can be configured to analyze users interactions with the engine to derive sets of parameters associated with different types of information, where the parameters are normalized to the types of information. In some embodiments, the interaction can include a search query. The interactions can also include other types of interactions beyond search queries. Once the engine analyzes the interactions and derives sets of normalized parameters, the engine can find a best combination of parameters to reflect the interactions. The best combination preferably includes at least two normalized parameters from two different sets stemming from different types of information (e.g., language, location, brand, names, etc.). Records are retrieved using the best combination and are ranked according to the best combination of normalized parameters, then presented to the user. Types of information are contemplated to include languages, industry sectors, goods or services, geographical locations, or other types of information. It is also contemplated that the records can include advertisements.

Various objects, features, aspects and advantages of the inventive subject matter will become more apparent from the following detailed description of preferred embodiments, along with the accompanying drawing figures in which like numerals represent like components.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 depicts the scheme of Claim 1 of this invention, where a user connection and a user query are used in the following steps: (1) discerning suspected geographic origins of the user; (2) detecting user language; and (3) using the language or the languages to evaluate the suspected origins.

FIG. 2 shows prior art methods used by U.S. Pat. No. 6,623,529, David Lakritz, Sep. 23, 2003, in determining the language and country of a web site visitor, and using the determination in retrieving documents from country/language databases.

FIG. 3 shows prior art methods used by US2004/0194099 A1, Lamping et al., Sep. 30, 2004, in dynamically determining preferred languages from user queries as well as from preliminary search results, in order to sort final search results with one or more preferred languages.

FIG. 4 shows prior art methods used by US2004/0254932 A1, Gupta et al., Dec. 16, 2004, in dynamically determining preferred country from user queries as well as from preliminary search results, in order to sort final search results with one or more preferred country.

FIG. 5 shows prior art methods used by US2006/0106778 A1, Laura Baldwin, May 18, 2006, in determining a geographic location from a user query. (This prior art also disclosed their utilization of user's browser's information in the same determining step.)

FIG. 6 depicts generally an embodiment of this invention, where a user connects to the system, submits a query, and the system retrieves and displays records.

FIG. 7 depicts the general steps of automatically discerning a set of suspected geographic origins of a user, using both the user's connection (e.g., a Web browser) and the user query.

FIG. 8 depicts the general steps of determining languages of the user, also using both the user's connection and the user query.

FIG. 9 depicts the general steps of using user languages in evaluating the goodness of individual members of the set of suspected origins.

FIG. 10 depicts the general steps in evaluating combinations of languages and locations.

FIG. 11 depicts a possible method of providing records to a searcher.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable media. For example, a server can include one or more computers operating as a web server, database server, or other type of computer server in a manner to fulfill described roles, responsibilities, or functions. One should appreciate the disclosed techniques also provide advantageous technical effects including increased efficiency of finding relevant search results or decreased search times.

As discussed above, the inventive subject is considered to include identifying records based on driving parameters according to normalized types of information. The following disclosure illustrates the inventive subject by providing an example based on language and location. One should note that language and location just two types of information from myriad other types of information. All types of information are contemplated.

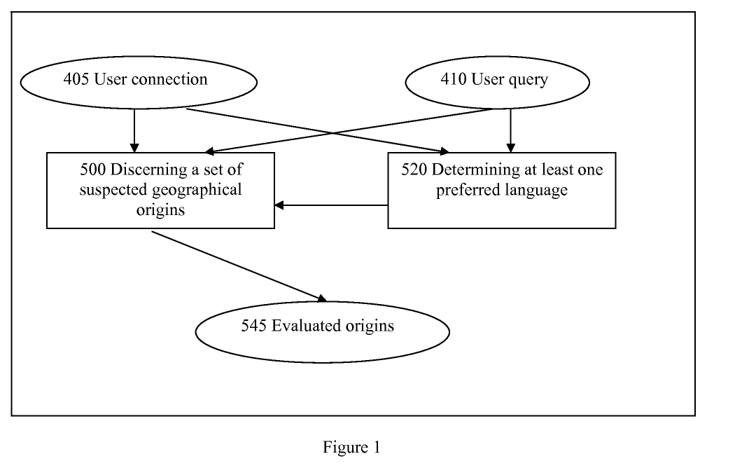

FIG. 1 depicts a class of methods that automatically discern 500 a set of suspected geographical origins from which a user may have connected to a server through a user connection 405, identify one or more languages of a user query 410, use the languages to evaluate applicability of each of the suspected origins 545, determine 520 at least one preferred language, and use the origins and languages in retrieving records and displaying them to the user.

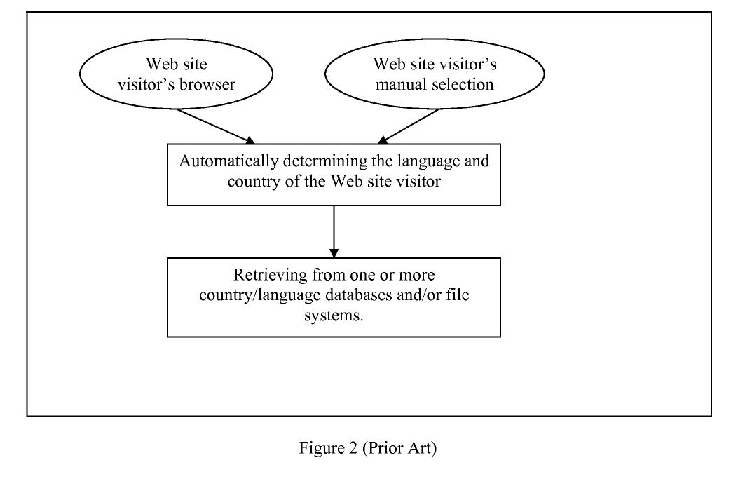

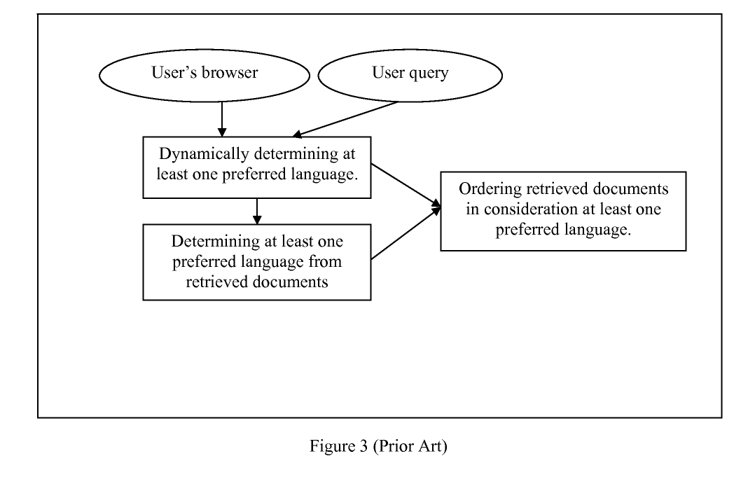

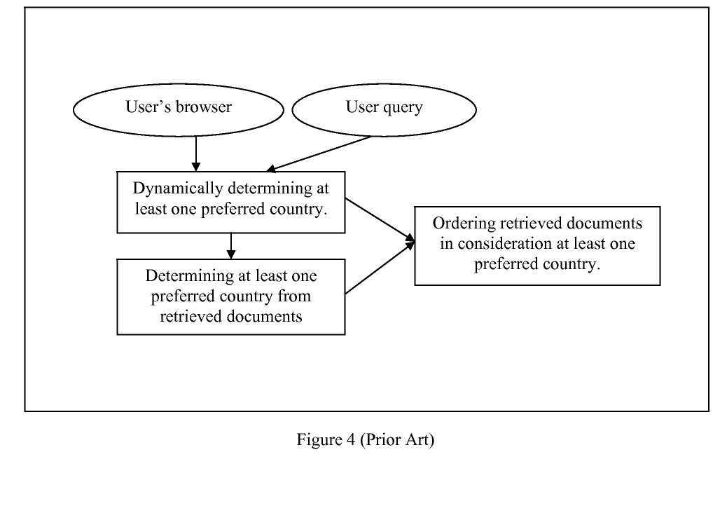

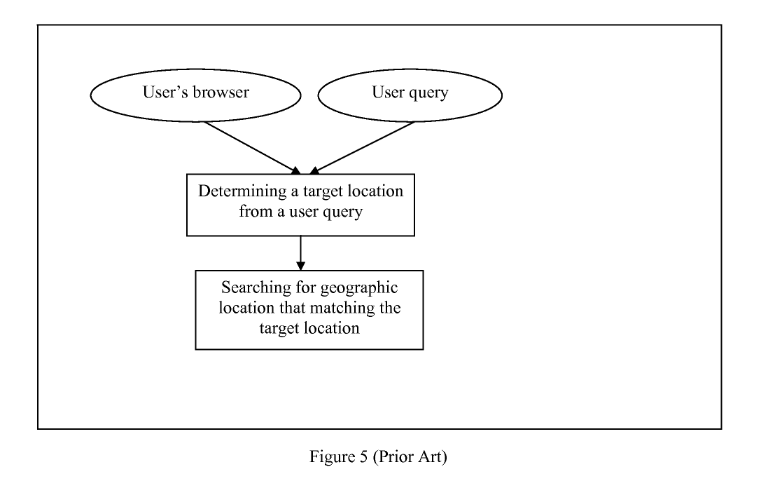

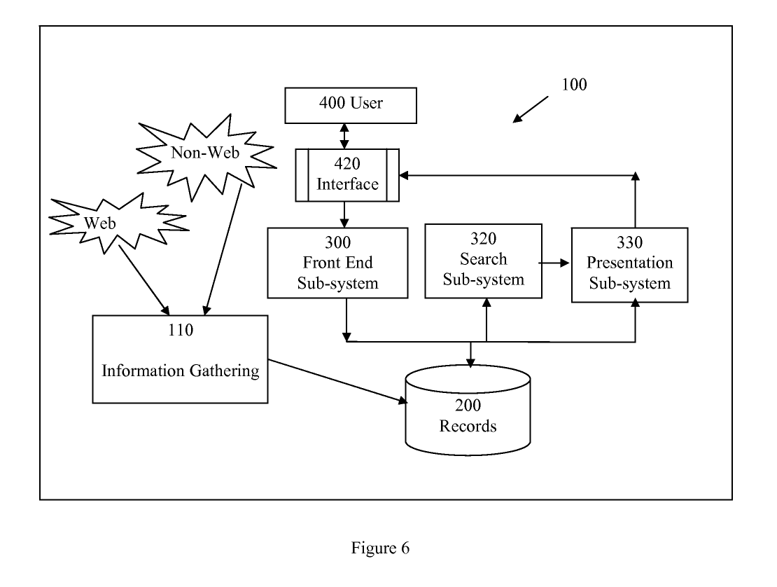

FIGS. 2-5 are prior art described in the Background section. FIG. 6 depicts generally an embodiment 100, where a user 400 connects to the system through the Interface 420. Through 420, a user query is submitted to the Front End Sub-system 300, which provides the user query as well as other information, to the Search Sub-system 320, which finds matches among records stored on 200 Records Repository. The Presentation Sub-system 330 is provided with matching records as well as other information from 300 and 320, and display records on the Interface 420. Records on 200 have been processed from information gathered by 110 Information Gathering Sub-system from Web or non-Web sources before a user connects.

Regarding 200 Records Repository, a record is associated with a geographic location, including but not limited to a postal code, a district, a non-political region, a city, a county, a metropolitan or micropolitan statistical areas for example, as defined by the US Census), a country, and a continent. For example, a post code could be “90210” or “310013”; a political district “Central, Hong Kong”; a city “Los Angeles” or “Hong Kong”; a county “Los Angeles County”; a non-political region “West Los Angeles” or “the Greater Los Angeles” or “the West Coast” or “New England”; a metropolitan or micropolitan statistical area “Norfolk-Virginia Beach-Newport News”; a country “United States of America”; a continent “North America”.

A record is also associated with at least one language. A language could be “English”, “American English”, “British English”, “Chinese”, “Cantonese”, “Chinese simplified”, “Chinese traditional”, or “Chinese Hong Kong”. Further, a record comprises information in the form of text, or of rich media format (e.g. audio, video, image), or a combination.

Still further, a record could be a combination of other records. For example, a record labeled as “Record A” could be about a company's general introduction, and is combined from three records, “Record A1”, “Record A2”, “Record A3”, and “Record A4”, where “Record A1” is textual and associated with the geographical location “China mainland” and the language “Chinese simplified”, “Record A2” is textual and associated with the geographical location “California” and the language “US English”, “Record A3” is a video with Chinese dubbing and associated with “China mainland” and the language “Chinese simplified”, and “Record A4” is a video with English dubbing and associated with “California” and “US English”.

Still further, records on 200 Records Repository are partitioned. For example, one partition of the records could comprise web pages from a company, and another partition could comprise advertisements in textual or rich media format from a same company.

Through out the discussion below, it is intended that a method applied to one partition might not be the same for another partition.

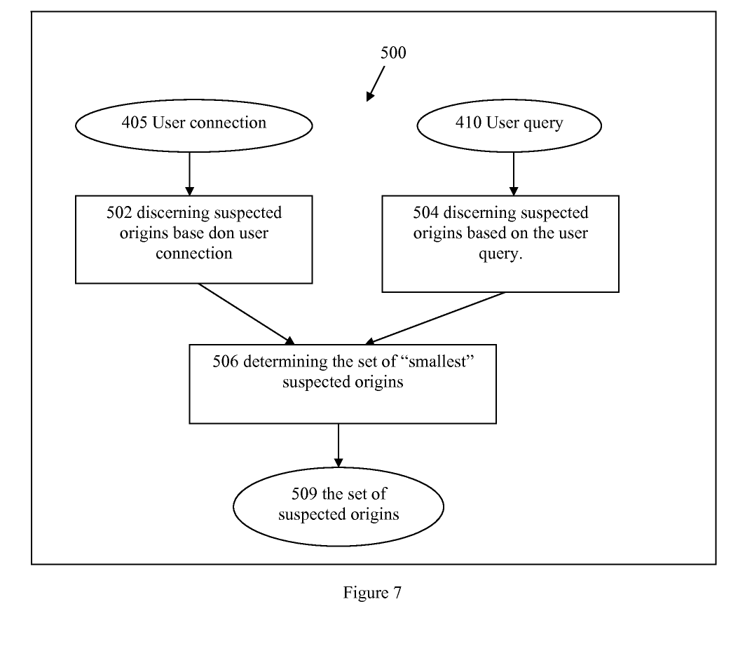

FIG. 7 depicts Step 500 of automatically discerning a set of suspected user origins 509, which generally comprises a user connection 405, a user query 410, step 502 discerning origins from the user connection, step 504 discerning origins from the user query, and step 506 deciding on a set of “smallest” suspected origins. A geographical origin is the geographical location from which the user connects to the server.

A user connection 405 preferably is from a computer (desktop, laptop, workstation, server, etc.), alternatively from a cell phone, or a PDA, or others. In prior art US2004/0254932 A1, Gupta et al., Dec. 16, 2004, various such connections are disclosed in paragraph 0030.

In Step 502, different methods are applied to different connections, to name a few below.
A) A client computer connecting using the HTTP protocol. Typically the client uses a web browser, which transmits various piece of information, as specified by the Common Gateway Interface protocol, including but not limited to (1) the client's Internet Protocol (IP) address which can be used via Reverse IP lookup in order to map to geographic locations. This is disclosed in both US2004/0194099 A1, Lamping et al., Sep. 30, 2004, paragraph 0081, and US2006/0106778 A1, Laura Baldwin, May 18, 2006, paragraph 0038; (2) the client's hostname, which can be mapped via Domain Name Resolution to geographic locations. This is also disclosed by the above two prior arts; and (3) with certain software such WebPlexer, country can be automatically determined, as disclosed in U.S. Pat. No. 6,623,529, David Lakritz, Sep. 23, 2003, section 3.4.1.
B) A client providing a phone number. A cell phone client could provide this information. The phone number's country code, area code, central office code, as well as the other parts of the phone number, can all be used in mapping into geographic locations.
C) A client providing GPS coordinates. GPS coordinates can be mapped into geographic locations.

In Step 504, the user query string is analyzed for information suggestive of geographical locations. Some of the methods are discussed below:
(504A) Looking for a proper name for geographic locations such as “Los Angeles”, “Shanghai”, the Chinese equivalent of “Shanghai”, a location's nickname such as the “Big Apple”. This method is generally disclosed in US2006/0106778 A1, Laura Baldwin, May 18, 2006, paragraph 0040.
(504.B) Looking for information other than proper names suggestive of geographic locations. For one example, in the query “flying from LAX to JFK”, two geographic locations are present.

In Step 506, at least two sets of suspected origins are merged, and the goal is to find the set of “smallest” geographical locations, whose preferred definition is that the union of members covers the smallest possible geographical area. For example, given the following two sets: (i) {“United States”}, and (ii) {“California”, “Oregon”, “Arizona”}, the method finds the latter set. All suitable algorithms are contemplated, including but not limited to lookup tables, greedy search algorithms, and shortest path algorithms.

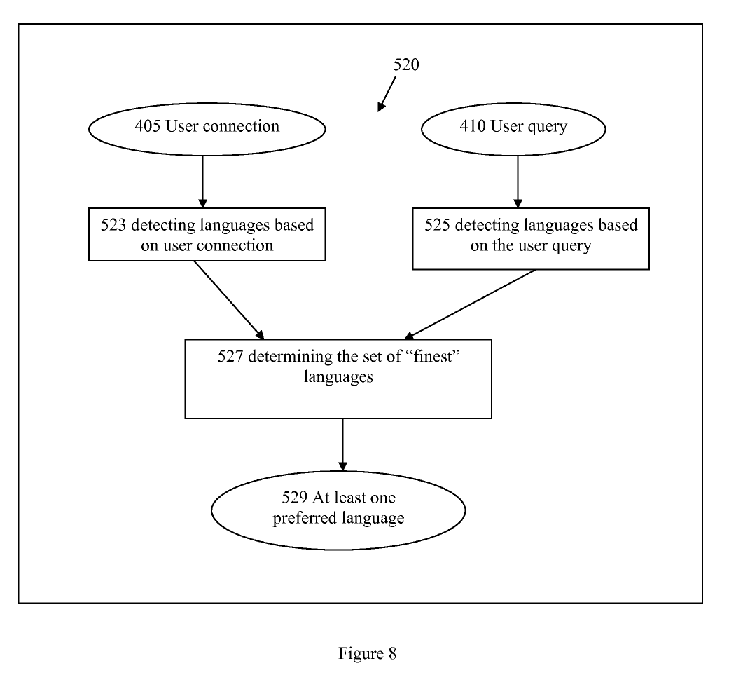

FIG. 8 depicts Step 520 of detecting languages the user uses, which generally comprises a user connection 405, a user query 410, step 523 of detecting languages from the user connection, step 525 of detecting languages from the user query, and step 527 of merging the previous detections into a set of languages.

In Step 523, different methods are applied to different connections, to name a few below.
(523.A) A client computer connecting using the HTTP protocol. A web browser transmits various piece of information, as specified by the Common Gateway Interface protocol, and additionally through request message header, including but not limited to (1) the language accepted by the client's web browser. This is disclosed in prior art U.S. Pat. No. 6,632,529, David Lakritz, Sep. 23, 203, section 3.3.4, as well as in US2004/0194099 A1, Lamping et al., Sep. 30, 2004, paragraph 0079 and 0080; and (2) the client's operating system (such as “Microsoft XP Chinese”). Such information can be mapped into geographic locations. For example, “Microsoft XP Chinese” could be mapped to languages of {“China simplified Mainland China”, “Chinese simplified Singapore”}.
(502.B) A client providing a phone number. A cell phone client could provide this information. The phone number's country code is readily mapped into at least one language. Sometimes the area code is readily mapped into at least one dialect (e.g., Cantonese in parts of China).

In Step 525 of detecting languages from the user query, some contemplated methods are listed below.
(525.A) Technology for language identification for a text string is well known, e.g., the Rosette Language Identifier software from Basis Technology, Inc.
(525.B) In the case of a user query string composed of at least two different languages, new method is developed by this invention, so that a query string is first segmented into different parts, and each part is further detected of its preferred languages.

In Step 527, at least two sets of languages are merged into one set. The goal is to find a set of “finest” languages. For example, given two sets, (i) {“English”, “Chinese”}; (ii) {“American English”, “Chinese”}, the former is found. All suitable algorithms are contemplated, including but not limited to lookup tables, greedy search algorithms, and shortest path algorithms. In a next step, the system derives at least one preferred language 529.

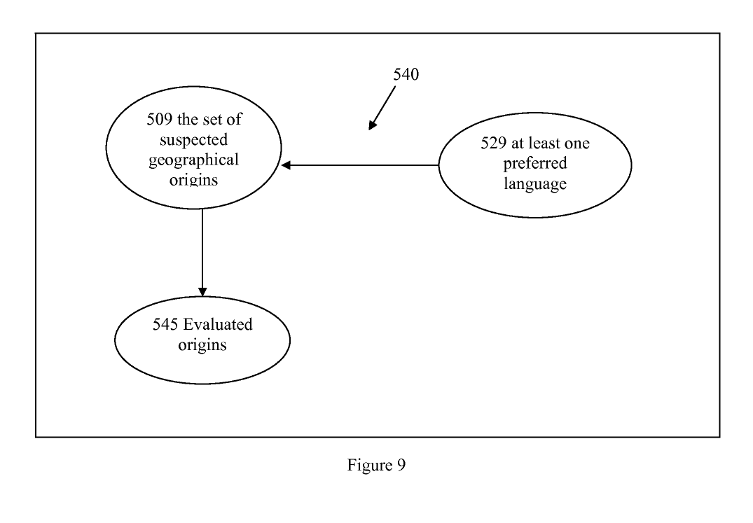

FIG. 9 generally depicts a contemplated strategy 540 for using at least one preferred language 529 to modify the set of the suspected origins 509, and associating a confidence measure on every element in the set of origins. The result is the evaluated set of origins 545.

The system has knowledge on mapping from languages to geographical locations. One piece of knowledge could be (“Chinese simplified”=>{(“China mainland”, 0.9), (“Singapore”, 0.4), (“China Hong Kong”, 0.1)}. This piece knowledge states that the language “Chinese simplified” corresponds to three geographical locations each of which is associated with a confidence measure of 0.9, 0.4 or 0.1 respectively. Suppose there is a set of suspected geographical origins {“China mainland”, “China Hong Kong”, “Singapore”, “Taiwan”}, and a user query's language is identified as {“Chinese simplified”}, then applying the above piece of knowledge to the set of origins could lead to the removal of the element “Taiwan”, and the remaining three elements are associated with confidence measures partially derided from the piece of knowledge.

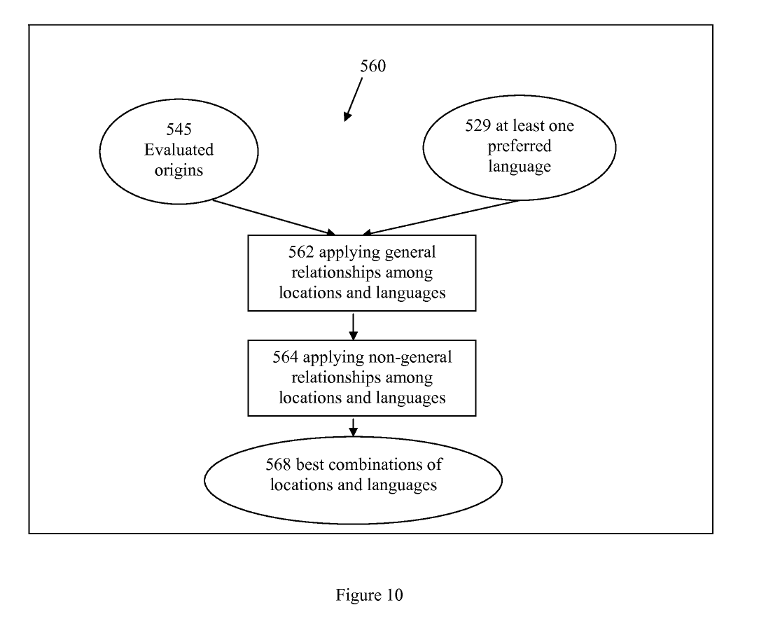

FIG. 10 depicts methods in finding the best combinations of locations and languages, which generally comprises the evaluated set of origins 545, the languages 529, Step 562 applying generally relationships among languages and locations, and Step 564 applying non-general relationships among languages and locations. The result is the best combinations 568.

In Step 562, general relationships among languages and locations are applies in order to evaluate combinations. Such relationships comprise commonly known language and location combinations that exist. For example, given the set of origins {“London”} and the languages {“US English”, “UK English”}, then the combination of (“London”, “UK English”) is evaluated as a preferred one to (“London”, “US English”). The system stores such relationships, with one embodiment in a lookup table.

In Step 564, non-general relationships among language and locations are applied. Some sets of such relationships are listed below.
(564.A) One set of such relationships are those of local nature. For example, regions such as Montreal have two prevailing languages, and this local relationship overrides the general relationship of (“Canada”, “English”).
(564.B) Another set of such relationships are those inheritably “conflicting”. For example, a user connects from Shanghai, using a browser on a Microsoft XP Chinese operating system, submitting a query in simplified Chinese that has “90024” in it. The suspected origins are thus {“Shanghai”, “90024”}(90024 is a zip code in Los Angeles), and the language {“Chinese simplified”}. Consider the relative goodness of the two combinations: (“90024”, “Chinese simplified”) and (“Shanghai”, Chinese simplified). The first combination might well be what the user is seeking (information relevant to the zip code, and in simplified Chinese), however, there is very little such information exits. The second combination might not be what the user is seeking, but there is a large amount of such information exists. Such relationships are accumulated through interviewing experts and by collecting statistics, and stored on the system. One embodiment is the storage is lookup tables, another embodiment probability rules.

Once the suspected origins, the languages, and the best combinations of the two, are derived, they are used in retrieving and displaying records.

As stated above, a record on 200 Record Repository has been associated with a geographic location and a language. The matching of a user's geographical origin and a record's geographical location is done at smallest geographical area possible. For example, if a set of origins is {“California”, “Arizona”}, and a location is {“Los Angeles”}, then the matching is “Los Angeles”.

At Search Sub-system 320, the matching of a query's language and a record's language is at the finest possible. For example, if a query's language is “Chinese”, and a record's language is “Chinese simplified”, then the matching is “Chinese simplified”. The Search Sub-system 320 retrieves those records whose geographical locations and languages match a user query with priority over those do not. Further, the best combinations 568 are applied in sorting the retrieved records. All suitable algorithms are contemplated, including but not limited to lookup tables, greedy search algorithms, or shortest path algorithms.

At Interface 420 where retrieved records are displayed, several methods are contemplated as below.
(420.A) If there are two combinations of location and language, display records in two areas, one for the first combination, and the other for the second combination. If there are more than two good combinations, records in the best two are displayed first.
(420.B) If combinations of locations and languages are not available, the following methods are contemplated:
   (420.B.1) If a user query has two suspected origins, our system displays records in two areas, one for the first origin, and two for the second origin. If there are more than two origins, records in the two with highest confidence measures are displayed first. Preferably records are displayed in two areas.
   (420.B.2) If a user query has two suspected languages, our system displays records in two areas, one for the first language, and two for the second language. If there are more than two languages, records in the two with finest languages are displayed first. Preferably records are displayed in two areas.

The previous discussion contemplates using normalized parameters associated with languages or locations to identify records. One should appreciate that the disclosed techniques can be equally applied to other types of information beyond geographic location or language. Other types of information can include industry sectors, goods or services, brands, times or dates, proper names, classes of products, families, or other classes or types of information. In some embodiments, each type of information used can be orthogonal to the other types of information. In other embodiments, the types of information can overlap. Preferably each type of information also has an associated list of normalized parameters representing informational items that relate to the type of information. For example, type “Language” could have normalized parameters {“English”, “Chinese”, “Spanish”, “Japanese”, etc} all encoded digitally (e.g., as strings, identifiers, pointers, etc.). Furthermore, the parameters could include text data, image data, audio data, logos, or other encodings. The following discussion assumes normalized parameters are text strings for clarity.

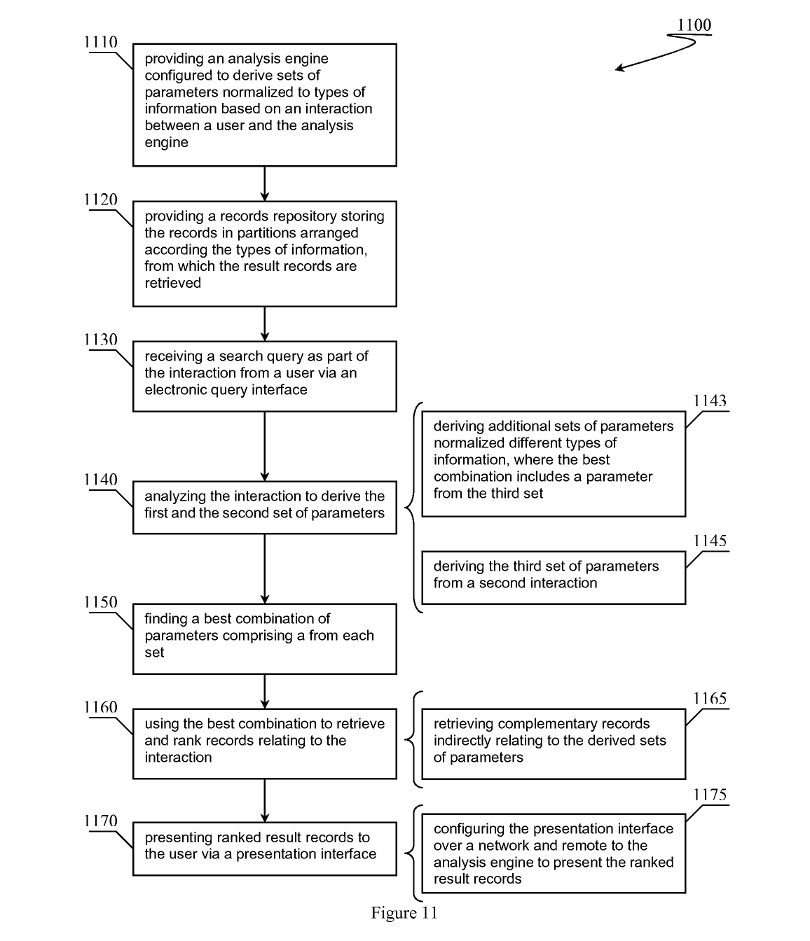

FIG. 11 presents possible method 1100 of providing results to a user based on an interaction between an analysis engine and the user. Method 1100 illustrates that the disclosed techniques can be applied in a generic sense to many different types of information beyond just language or location.

Step 1110 can include providing an analysis engine capable of analyzing interactions with a user. In a preferred embodiment, the analysis engine represents at least a portion of a search engine, Google™, for example. Analysis engine can be configured to analyze various interactions with a user including search queries. Other interactions can relate to the following: how a user interacts with the search engine, when interactions take place, where interactions take place, what interactions occur, with whom the interactions occur, or other types of interactions. For example, a user could submit one or more queries to an analysis engine on Mondays through a web services API. Analysis of such interactions could be brought to bear in subsequent steps of method 1100. Other types of interactions beyond search queries are also contemplated including gaming, blogging, interfacing to application software, emailing, viewing content, audio or video chatting, testing, exchanging metadata, or other types of interactions.

Step 1120 contemplates that a records repository can be provided where records are organized or otherwise arranged to according to types of information. The records can be indexed according to any desired schema that identifies a record as being relevant to one or more types of information. One should note that a record can be classified according to overlapping types of information, or even mutually exclusive types of information. As an example, considered a baked good could be belong to type “pastry”, to type “sweet”, or to other types of information. Furthermore, a record could be belong to mutually exclusive types, possibly where the types reflect opinions of different people. By partitioning records according to type, possibly even a priori defined types, the repository can be searched more quickly to identify records relating to the interactions with the user.

Records can be further tagged with parameters associated with types of information. In a preferred embodiment, the parameters are normalized to the types of information, where the normalized parameters represent metadata utilized as tags that are independent of a user's characteristics or interactions with the analysis engine. More specifically, the metadata can be language independent, culturally independent, region independent, or independent from being restrictive. Use of normalized parameters facilitates identifying records regardless of a language used to submit keywords and provides a bridge between strict key-word matching and concept mapping. For example a first user might submit a query containing “cow juice” while a second user might submit a query containing “leche”. Both queries could be analyzed by the analysis engine and determined to relate “dairy products” as type of information. The engine might further return records tagged with the normalized parameter “milk” of the type “dairy products”.

Step 1130 can include receiving a search query as part of an interaction between the user and the analysis engine. The search query can include a natural language query or a machine language query (e.g., SQL query, digital data, protocol data, etc.). In a preferred embodiment, the interaction comprises a search query submitted to an electronic query interface of a search engine. It is also contemplated that the interaction can include other components beyond the search query including metadata passed between the search engine and an application interfacing with the search engine. The metadata could be visible of invisible to the user.

At step 1140 the analysis engine can conduct an analysis of the interactions to derive sets of parameters that have been normalized to different types of information. A set of normalized parameters can include key-words from the query or parameters that have no apparent overlap with a query. The sets of parameters can be represented by a multi-valued object relating to a type of information. An example set of parameters for languages could be represented by {“Language”, {“Chinese”, “Cantonese”, “Mandarin”, “Hokkien”}}, where “Language” indicates a type of information and the following list represents normalized parameters associated with the type “Language”. It should be appreciated that a derived set of normalized parameters is likely a subset of all the normalized parameters available for a type of information. Furthermore, although the normalized parameters are presented as text data, the normalized parameters can also represented using other data types including encoded numerals, literals, strings, pointers, or other data types. It is also contemplated that the list of the set could be returned according a ranking, possibly a confidence level derived from one or more analysis algorithms.

Analysis of an interaction between a user and the analysis engine to derive sets of parameters can be conducted using many different techniques. In some embodiments multiple techniques are applied, where the normalized parameters are derived based on confidence levels associated with each technique. Example analysis techniques can include look-up tables, N-gram techniques, adaptations of Viterbi algorithms, adaptation of Bayesian networks, combinatorial optimization, genetic algorithms, simulated annealing, binary decision trees, heuristics, or other algorithmic techniques.

Step 1143 contemplates that an analysis engine can derive additional sets of normalized parameters beyond initial one or two sets of normalized parameters. The additional sets can be brought to bear against identifying relevant records. The additional sets of normalized parameters can also be derived from other aspects of an interaction beyond analysis of a query including time or date, location of a user, interaction history, ambient or passively collected data, protocols used, or other characteristics relating to the interaction. For example, a person could submit a query via their mobile phone. The mobile phone could also send collected sensor data (e.g., camera image, audio data, GPS information, orientation, acceleration, etc.) as part of the interaction. This data can also be analyzed to derive sets of normalized parameters, even through additional interactions as indicated at Step 1145.

One aspect of conducting an analysis can include segmenting the interaction into one or more segments relating to the interaction, possibly according to how a record repository is partitioned as discussed with respect to step 1120. For example, a user in Santa Monica could submit the query “Betty Crocker baking mix”. The analysis engine might segment the interaction into the brand “Betty Crocker”, the product class “baking mix”, and the region “area code 310”. These segments can further assigned to one or more types of information, again possibly according to how a record repository is partitioned. To continue the example, segment “Betty Crocker” might be assigned to the types “consumer goods”, “baked goods”, “recipes”, even brand type “Betty Crocker”, or other types of information. Such an approach can be achieved through look-up tables, inverted indexing, forward indexing, generic database query mechanisms, search engine techniques, or even human involvement. Naturally, each of these types of information can then be used to identify the normalized parameters for the types.

Step 1150 involves finding one or more best combinations of parameters from the various sets where the best combinations can include members from each set, preferably at least two members from different sets. To continue the previous example based on the query “Betty Crocker baking mix” submitted from an individual in Santa Monica, Calif., the types of information might includes “consumer goods”, “baking”, and “area code 310”. These types could result in the following sets of parameters {“consumer goods”, {“vegetable”, “vitamin”, “flour”, “sugar”}}; {“baking”, {“cake”, “muffin”, “cookie”} }; and {“area code 310”, {“Ralph's”, “Vons”, “Food-4-Less”, “Albertson's”}}. Based on analysis of the user interaction and the normalized parameters, one or more best combinations could be returned, for example {“cake”, “Ralph's”}, {“cake”, “flour”, “Vons”}, or other combinations. A best combination is considered to have a higher ranking (e.g., confidence level, rating, etc.) than others. It is also contemplated that multiple best combinations having the same ranking could be returned. In which case the user could be queried to break a tie or the combinations could be further analyzed. Some embodiments analyze relevance or synergy of cross-terms within the combination's parameters to identify a best combination, “cake” and “flour” might be more synergetic than “cake” and “Ralph's” for example.

Step 1160 can include using a best combination of normalized parameters to guide retrieval of result records relating to the interaction and to rank the results. The parameters can be used as a query into the record repository or can be used as an index to identify records within the partitions of the repository. Records having more than one parameter from the best combination would likely be ranked higher over records having a single one of the parameters. Records can be ranked according primary, secondary, tertiary, etc., or other ranking based on the parameters of the best combination as desired, or as discussed with respect to FIG. 10 and languages or locations above.

Step 1165 indicates that complimentary records can be identified, where the complimentary records indirectly relate to the derive sets of normalized parameters. Complimentary records can be indirectly identified by checking if the normalized parameters associated with a first type of information are also members of another, different type of information. If so, records relating to the different type of information can also be returned. Such an approach can be applied when searching for a bundle of products, a grocery list for example. When searching for “chicken” at a grocery store, the analysis engine could identify advertisements relating to restaurants that serve chicken, or serve a chicken dish that has ingredients from a grocery list.

Step 1170 can include presenting the ranked result record to the user via a presentation interface, preferably a web page over network and remote to the analysis engine (step 1175). As indicated above, it is also contemplated that the returned or ranked records can include advertisements.

Thus, specific embodiments and applications of searching with awareness of locations and languages and related improvements have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing records to a user, comprising:
providing an analysis engine configured to derive a first set of parameters normalized to a first type of information and a second set of parameters normalized to a second, different type of information, based on an interaction between a user and the analysis engine;
receiving at least a search query as part of the interaction from the user via an electronic query interface;
using the analysis engine to analyze the interaction to derive the first and the second set of parameters;
finding a best combination of parameters comprising a first parameter from the first set and a second parameter from the second set; and
using the best combination to guide retrieval of result records relating to the interaction and to rank the result records; and
presenting at least some of the ranked result records to the user via a presentation interface.

2. The method of claim 1, further comprising the analysis engine deriving a third set of parameters normalized to a third, different type of information, and wherein the best combination comprises a third parameter from the third set.

3. The method of claim 2, wherein the step of deriving a third set of parameters comprises deriving the third set of parameters derived from a second query.

4. The method of claim 1, wherein the first type of information corresponds to languages

5. The method of claim 1, wherein the first type of information corresponds to industry sectors.

6. The method of claim 1, wherein the first type of information corresponds to goods.

7. The method of claim 1, wherein the first type of information corresponds to geographical origins.

8. The method of claim 1, further comprising providing a records repository storing the records in partitions arranged according the first type and the second type of information, from which the result records are retrieved.

9. The method of claim 1, wherein the results records comprise an advertisement.

10. The method of claim 1, further comprising configuring the presentation interface over a network and remote to the analysis engine to present the ranked result records.

11. The method of claim 10, wherein presentation interface comprises a display of a mobile communications device.

12. The method of claim 1, wherein the step of using the best combination to guide retrieval of result records includes retrieving complementary records indirectly relating to the derived sets of parameters.
